(19) United States
(12) Patent Application Publication
(10) Pub. No.: US 2002/0110246 A1
(43) Pub. Date: Aug. 15, 2002

(54) Wireless audio system

(76) Inventors: Jason Gosior, Edmonton (CA); Kip Hampson, Edmonton (CA); Lee Kruszewski, Edmonton (CA); John Sobota, Edmonton (CA)

Correspondence Address: Alan J. Atkinson, P. O. Box 270161, Houston, TX, 77277-0161, US

(21) Appl. No.: 09/784,293

(22) Filed: Feb. 14, 2001

(51) Int. Cl. G06F 17/00; H04H 5/00

(52) U.S. Cl. 381/2; 700/94

(57) ABSTRACT

A system for wireless transmission between a device such as a game controller and a base transceiver linked with a host device. Multiple controllers can be linked with the base transceiver through radio frequency transmission, and audio signals can be selectively transmitted there between. Audio commands can be introduced with manual controls at the controller for transmission to the base transceiver. Audio signals can be generated, mixed or otherwise processed by the combination of the host device and base transceiver for selective transmission to one or more controllers. The combination of manual switches, audio commands, and radio frequency transmission provides unique combinations of interaction between a person and the host device.

### BACKGROUND OF THE INVENTION

The invention relates to the field of bi-directional audio signal communication, recognition and synthesis. More particularly, the invention relates to audio communication for electronic game controllers, consumer electronic devices, telecommunications devices, computing and related devices.

Family entertainment rooms typically provide different and interactive activities for one or more persons. New informational, computing and telecommunication functions are integrated into traditional audio/visual equipment such as set top boxes and game consoles and are appearing in hybrid computing devices in stationary or hand-held configurations. Conventional desktop functions are driven by keyboard and “mouse” devices. In other operating environments such as family entertainment rooms, desk surfaces do not exist to support keyboards and mouse devices. In addition, keyboards and mouse devices are easily damaged if liquids and food particles contact such devices.

The family entertainment room environment is typically occupied by multiple persons each participating in activity inherently disruptive to the others. The sound, video, or physical equipment from one activity may interrupt another person's participation in a different activity. If children are playing a video game and their parents are reading, sound from the video game invariably interrupts the peace. Accordingly, a need exists for gaming systems permitting audio participation without interference with other persons.

Electronic game programs operate on various game host devices such as video game consoles, set top boxes, consumer electronics, and personal computers. Electronic games use software and hardware devices to simulate game situations and experiences through visual, audio and mechanical stimuli. In addition, game host devices also support other communications and entertainment capabilities such as e-mail, web browsing, MP3 music, Internet telephony that place new multi-function demands on both the game host devices and the controllers.

User interaction with these games is typically provided through a hand-operated controller that permits the person to change the game operating parameters, direction, or response, and also to receive mechanical, audio or visual feedback from the game host device directly or through the controller.

Many electronic games are fast moving and draw the user into fast moving responses integrating the person into the game. The more interactive and targeted to the individual the experience, the higher the level of this integration and game satisfaction. Popular games require fast reflexive responses to the game situation and format and require the transmission of large data sets.

In addition to hand operated manual controls, the game controller may also have a built in audio interface consisting of a speaker and microphone. Game controller audio capabilities increase the game interface interactivity level by adding an additional interactive interface. Audio capabilities amplify a player's capabilities when combined with multi-step voice triggered commands, and facilitate more traditional communication capabilities such as receiving telephone signals or e-mail or voice mail messages.

To provide audio interaction, one or more wires lead from a controller plug-in jack to a headset comprising a speaker and microphone. Hard-wired remote audio capabilities greatly extend the utility of a game controller and similar devices for the new informational, computing and telecommunication applications.

Various examples of devices having audio or voice recognition capability exist in the prior art. U.S. Pat. No. 6,097,441 to Allport (2000) describes a system in which a video game controller, with mechanical inputs, audio, graphical and video capabilities, interacts with a base station unit. U.S. Pat. No. 4,445,187 to Best (1984) describes a video game system by which human viewers conduct simulated voice conversations with game characters.

U.S. Pat. No. 6,167,253 to Farris et al. (2000) describes a system where web pages and audio information are retrieved in a mobile telephone network using a predefined vocabulary voice recognition system. U.S. Pat. No. 6,038,534 to Richards (1997) describes a system that converts voice commands into keyboard signals to provide input to a personal computer. U.S. Pat. No. 5,774,859 to Houser et al. (1998) describes a system which converts voice commands into television controls. U.S. Pat. No. 5,844,824 to Newman et al. (1998) describes a portable computer accepting audio and other command signal types for computer program control and wireless voice communications control for hands-free work applications. U.S. Pat. No. 5,893,064 to Kudirka et al. (1999) describes a voice recognition system for controlling computer gaming or other applications on a computer, where the voice recognition capability is programmable by way of a graphical user interface on the computer.

Hard wired controllers tethered directly to a host device typically permit interaction between users and an electronic game program. These controllers are capable of reliable and fast signal communication, however such controllers require wires leading from the controller to the host. Wires present a tripping safety hazard and further limit the operating mobility of the users relative to the game host device. Such wires are also an impediment to other individuals moving in a common area who are not participating in the game.

To eliminate the disadvantages of hard wires, certain game controller systems transmit data signals with wireless infrared (IR) controllers. Such controllers are limited because they can be interrupted if either the IR controller is inadvertently pointed away from the IR receiver on the electronic host device or someone or something blocks the point-to-point IR light beam. The effective data transmission bandwidth possible with an IR controller is also limited, thus reducing the level of interaction possible.

Various examples of wireless controllers exist in the prior art. U.S. Pat. Nos. 6,078,789 to Bodenmann et al. (2000) and 5,881,366 to Bodenmann et al. (1999) disclosed systems for RF wireless transmission between various personal computer peripherals and a personal computer running a game or other software.

U.S. Pat. No. 5,605,505 to Han et al. (1997) described a two controller infrared wireless system for a game host device. U.S. Pat. No. 4,531,740 to Green et al. (1985) disclosed a remote controller system for a video computer game using RF transmission as a communication mechanism. U.S. Pat. No. 5,806,849 to Rutkowski (1998) described a long-range signal transmission system for stadium gaming or other such gaming applications. U.S. Pat. No. 5,618,045 to Kagan et al. (1997) described an all-to-all controller gaming network using an arbitrary wireless network between game controllers having individual graphical displays and game processors.

U.S. Pat. No. 5,867,223 to Schindler et al. (1999) described a system which assigns and transmits audio programs to audio output devices in home entertainment applications.

U.S. Pat. Nos. 5,001,763 to Moseley (1991) and 5,524,058 to Moseley (1996) described devices which actively cancel environmental noise in headset devices in order to reduce the amount of such noise that enters the ear versus the desired signal produced by the audio system. U.S. Pat. No. 5,715,321 to Andrea et al. (1998) described a head set for voice recognition and other voice applications equipped with noise cancellation technology for the input microphone.

### SUMMARY OF THE INVENTION

The invention discloses a system for wireless interaction between an operator and a program. The system comprises a host device for supporting the program, a base transceiver engaged with said host device which comprises a processor core and a radio frequency transceiver and voice recognition and generation capability, and a controller operable by the operator which comprises a processor core, a radio frequency transceiver for wireless communication with said base transceiver radio frequency transceiver, and an audio input and output interface.

### BRIEF DESCRIPTION OF THE DRAWINGS

FIG. 1 illustrates a schematic view of a game controller, base transceiver, host device and displays.

FIG. 2 illustrates a schematic view of a game controller having an integrated headset, where the features of the headset are further detailed.

FIG. 3 illustrates a representative transmission sequence.

FIG. 4 illustrates a base transceiver transmission sequence to multiple controllers.

FIG. 5 illustrates a controller response transmission sequence for a wireless controller.

FIG. 6 illustrates a schematic view of data flow through a processing unit.

FIG. 7 illustrates a schematic view for a controller subsystem.

FIG. 8 illustrates a schematic view for a base transceiver subsystem.

FIG. 9 illustrates an elevation view of a game controller.

FIG. 10 illustrates a table showing possible mode transitions.

FIG. 11 illustrates a schematic view of data input sources and data outputs.

FIG. 12 illustrates potential controller key-based commands for a simulated keyboard.

FIG. 13 illustrates the process of editing commands in the program audio mode.

FIG. 14 illustrates the voice command component fields.

FIG. 15 illustrates a table of voice command editing commands.

FIG. 16 illustrates a table used to map internal code representations of controller inputs to host device command codes.

FIG. 17 illustrates a user-defined profile table for a keyboard type application.

FIG. 18 illustrates a user-defined profile table for a game type application.

### DESCRIPTION OF THE PREFERRED EMBODIMENTS

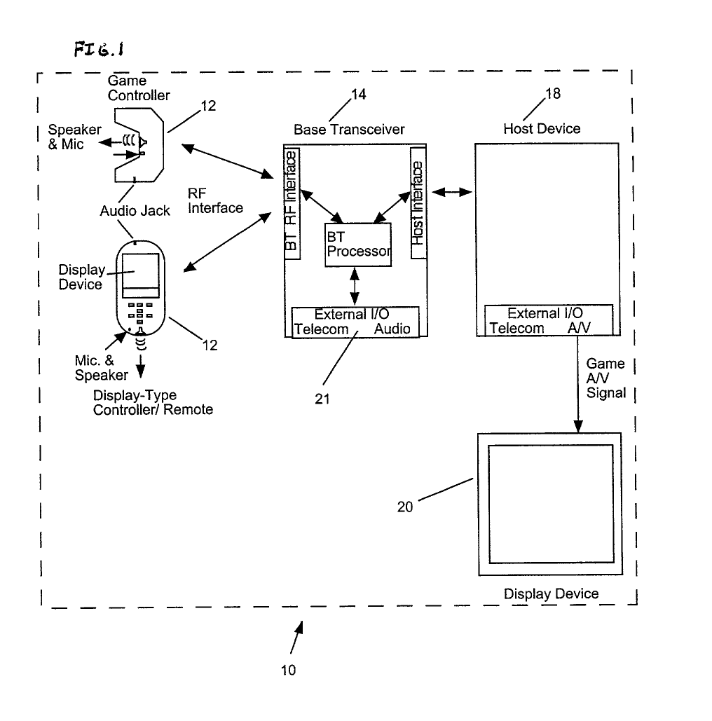

The invention provides bi-directional audio signals and audio control for video gaming, audio entertainment, informational, computing and telecommunication applications. As shown in FIG. 1 for a game system 10, game controller 12 enters game inputs and provides feedback to the players and base transceiver 14 receives and sends wireless signals to and from controller 12. Game host device 18 incorporates a resident application and display device 20 from which the players can view game play or interact with other host supported applications.

As described more thoroughly below, system 10 provides a powerful bi-directional audio control and targeted audio feedback capability for informational, computing and telecommunication applications. System 10 has the capability of recognizing and outputting audio signals from the controller 12 by applying voice command recognition, voice command profile and voice generation functions. The invention processes audio signals from a game host device 18 or external sources and transmits these processed signals wirelessly to one or more game controllers 12 through base transceiver 14.

In traditional wired and wireless controllers the link from the controller to the game host device is used for the transmission of game controller and remote control information. This information includes key presses, joystick movements by the user, and feedback such as rumble motor control, device configuration and other control information from the game host device.

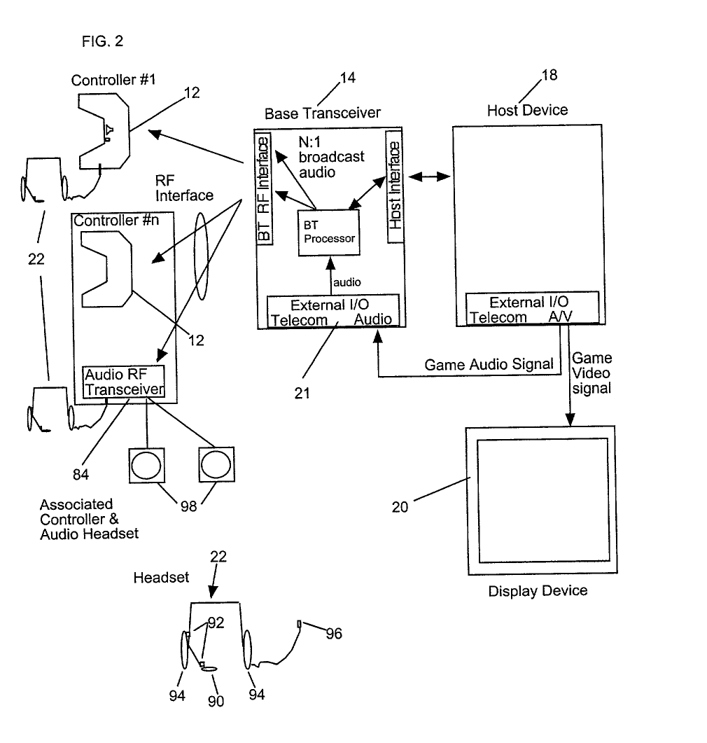

The present invention uniquely uses this type of link to carry additional bi-directional processed audio signals or data signals associated with such audio signals. These audio signals are entered or played back through controller 12 by headset 22 as shown in FIG. 2, entered through external interfaces on the base transceiver 14 or received from signals from the game host device 18.

FIG. 1 illustrates a representative overall configuration for system 10 in the form of a game system 10. Controllers 12 can comprise various types with various mechanical, audio, and visual input and output devices. Typical inputs for gaming consist of analog and digital buttons, joysticks, triggers and the like. Typical outputs consist of “rumble” motors providing force feedback to the hands of the game controller 12 user.

As shown in FIG. 2, headset 22 includes microphone inputs and speaker outputs either embedded in game controller 12 or preferably appended to controller 12. Headset 22 contains a microphone 90, sound cancellation devices 92 (input and output) and speakers 94 and is connected to game controller 12 by a plug-in jack 96. In other embodiments of the invention, an independent wireless headset 22 associated with controller 12 by the base transceiver 14 can be used as illustrated in FIG. 2 by 84.

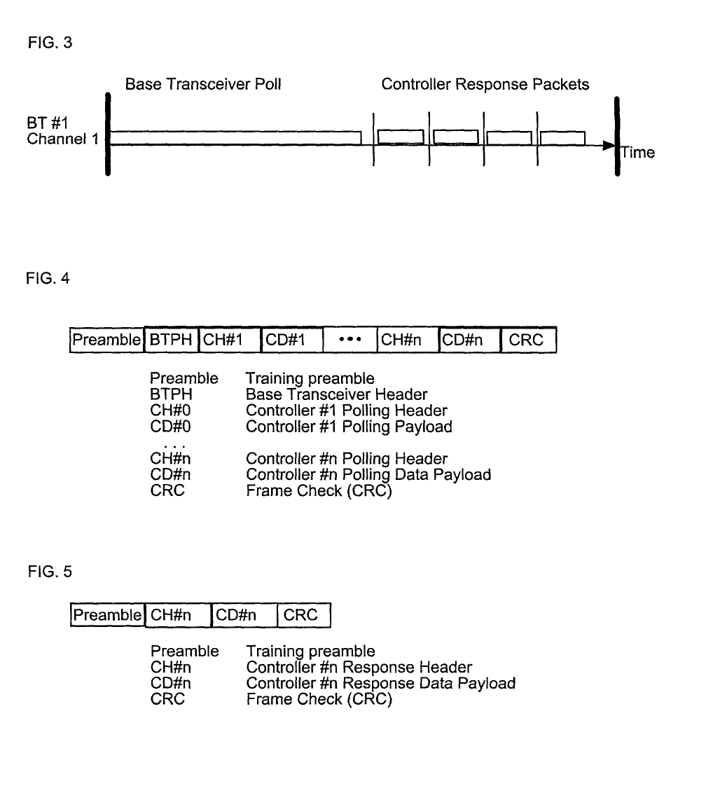

System 10 supports one or more base transceivers 14 each engaged with one or more game controllers 12. Base transceiver 14 is wirelessly linked to controllers 12 in a master-slave arrangement, and base transceiver 14 is the master. As indicated by FIG. 3, on a given channel frequency, base transceiver 14 polls for controller 12 input and sends data to each controller 12 in the same poll. Base transceiver 14 then receives responses from controllers 12 in a time-division duplex configuration. Each base transceiver 14 has a different instantaneous operating frequency and communication to their associated controller 12 groups occurs using time division duplex techniques.

The packet format for the polling packet is shown in FIG. 4 and consists of a preamble for synchronization and DC-offset compensation purposes. Such format also contains a base transceiver 14 header packet containing system information and control information targeted to attached controllers 12 and information requesting new controllers 12 to join if system capacity has not been exceeded. Each controller 12 is addressed and sent information by separate controller polling header and controller polling payload data fields. The integrity of the poll packet is checked with a 16 bit frame check sequence.

The format for the controller response packets in FIG. 3 is shown in FIG. 5. Such format consists of a preamble for synchronization and DC-offset compensation purposes. The preamble is followed by a header packet containing control information and a data field carrying information destined for base transceiver 14. The integrity of the poll packet is checked with a 16 bit frame check sequence.

The wireless communications link is of sufficient speed and quality to support multiple audio-enabled controllers 12. On a given channel frequency four or more such audio-enabled controllers 12 are supported with bi-directional data throughput rates per controller 12 of at least 32 kbps. The higher the throughput data rate, the higher the audio quality and the more other controller 12 data that can be carried. This rate and the cost of the system implementation can be reduced further if audio data quality can be lessened.

Radio transmissions are susceptible to RF noise interference. To reduce the effect of interference, system 10 uses spread spectrum techniques such as error-correction coding and frequency hopping. The preferred coding method uses Hamming codes with 1, 2 or 3 bit error correction, although other coding methods known in the art can be used.

The frequency of transmission is preferably at 900 MHz ISM band, 2.4 GHz ISM band, or other FCC-approved, low power license exempt communications frequencies. Frequency hopping can avoid continuous operation in a spectral channel with poor transmission characteristics. To minimize the system complexity and cost, the frequency hopping interval can be set to 60 hops per second or another suitable hopping rate.

Base transceiver 14 is connected to game host device 18 to collect and integrate input from host device 18 and other externally connected signal sources. Base transceiver 14 processes command data and other data, audio, and telecommunications signals moving to and from controllers 12. Base transceiver 14 may obtain its power from game host device 18 or have an independent power supply.

Base transceiver to host device interface 74 supports numerous types of game host devices 18 and is thus customized on a per game host device 18 basis. The interface to host device 18 may be directly wired connection with parallel digital signals or may be of another type such as RS232, USB, IEEE 1394, SPI or other. New digital interfaces are easily accommodated by changing the host interface 74 in the base transceiver ASIC 24 or the associated firmware or both.

Base transceiver 14 external input/output interfaces 21 support audio inputs and telecommunication interfaces. All analog audio signal inputs into base transceiver 14 and controller 12 are converted to digital format by an analog to digital converter present in an application specific integrated circuit (ASIC) and then processed and transmitted digitally within the system. Audio signals are compressed (uLaw, A-Law, 80 PCM or other) and preprocessed prior to radio frequency transmission to conserve bandwidth. This can be done by the ASIC or with common chipsets such as TLV320AC56 voice CODEC by Texas Instruments which has digital to analog and analog to digital conversion and amplifier circuitry for driving headset speakers 22.

The base transceiver 14 external audio inputs consist of a game host device 18 input and separate inputs targeted to each game controller 12. Various types and combinations of multi-channel audio signals, including mono, stereo, surround sound, 5 channel and other configurations are supported. Game host device 18 audio input is broadcast to all connected game controllers 12 so each player can hear this signal individually and simultaneously through their headsets 22. The separate audio inputs per game controller 12 allow each player to introduce personalized audio signals into the system from various sources such as CD players, streamed IP audio from MP3 players, stereos, and other devices. The signal from individual separate audio inputs is level adjusted and mixed digitally with game host device 18 audio input by the processor within base transceiver 14. The combined signal is then sent to each individual game controller 12.

The audio input connectors can comprise RCA type or audio plug type, however the RCA-type is preferred for the game host device 18 signal and the audio plug type or the RCA-type is useful for the separate audio inputs. Differing audio-type connectors can be used to support various types and combinations of multi-channel audio signals, including mono, stereo, surround sound, 5 channel and other configurations. Satellite speaker configurations as shown in FIG. 2, 98 can be added to controllers 12 or independent audio RF transceivers 84 to support various audio configurations. The firmware on the controller 12 and base transceiver 14 is changed to support a given audio configuration, with the preferred default configuration supporting 2 channel stereo sound.

The base transceiver 14 telecommunication interface supports telephony and data-type applications. Depending on the configuration of base transceiver 14 such interface may include physical connections and electronics for telephony and data communications. RJ11 type connectors are used for telephony applications. RJ45 type connectors are used for voice or data connections. For traditional telephony applications many telephony electronics are available off the shelf. The analog voice component is converted to a digital signal. For internet protocol (IP) telephone applications, IP telephony signals are extracted from an ethernet-based IP signal. Standard electronics also exist for ethernet interfaces. Although these are the preferred configurations, numerous other connector types, interface types and data formats can be supported.

Game host device 18 runs the game application and other related data, audio and video applications. Game host device 18 provides power or command data or audio and can provide other data and telecommunications signals to base transceiver 14 depending on the application and the capabilities of the host device 18. Host device 18 is connected to display device 20 such as a television or similar output device or devices with video and audio output capabilities such as computer monitors and stereo sound systems. The host device 18 may also be connected to internet protocol (IP) data networks or telephone networks and incorporate interfaces and run applications to support these and other network types.

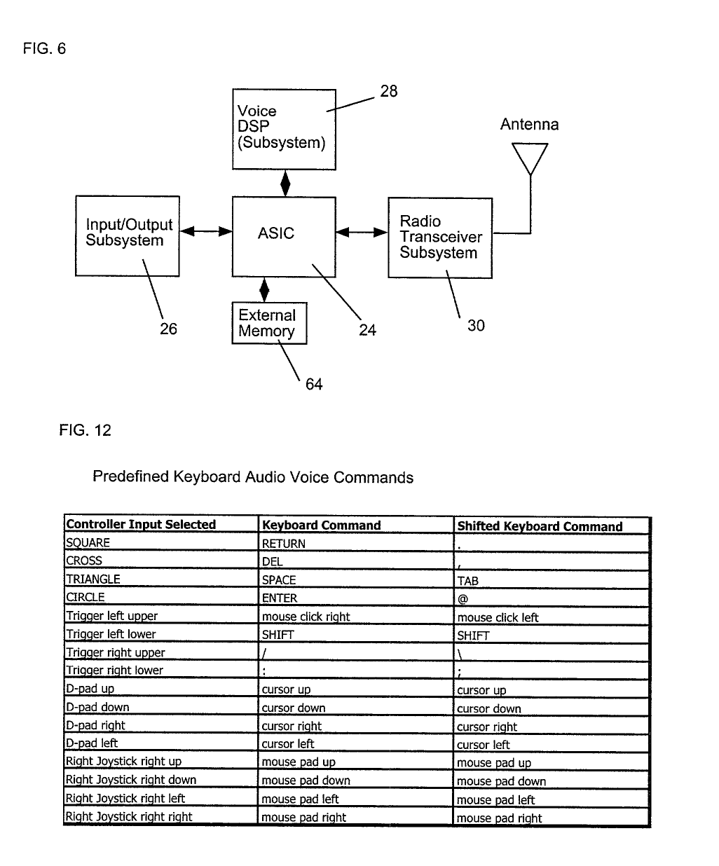

Referring to FIG. 6, both controller 12 and base transceiver 14 can have a similar design. Both devices incorporate an ASIC 24 designed to provide general processing and input/output functions through input/output subsystem 26. Tightly coupled with ASIC 24 is an external flash memory 64 for storing persistent program, system and application data. An external RAM memory 64 is also supported to extend the total system memory for larger applications. Such memory may also be incorporated directly into the ASIC 24 depending on desired the cost and complexity of this device. A voice digital signal processor system (DSP) consisting of one or more commercially available chips and electronics components can provide voice command recognition, voice processing and voice generation capabilities. Such a system is referred to as a voice DSP 28 throughout this invention.

Input/output subsystem 26 contains electronics that convert signals to formats usable by ASIC 24 and also to convert digital outputs to analog signals to control and send signals to devices both internal and external to system 10. These functions can be partly or completely incorporated in the ASIC 24 design depending on the application, output power levels, and other requirements for a given application.

Voice subsystem 28 performs voice coding/decoding functions, voice command recognition, and voice generation functions. In a preferred embodiment of the invention, voice pre-processing is performed by controller 12 to simplify function and to reduce cost. The voice command recognition and voice generation functions can be performed by base transceiver 14 (preferred) or by game host device 18. Low power solutions to perform voice recognition and generation functions are known in the art.

Controller 12 pre-processes the audio by converting audio to digital format and compresses audio for transmission. Such compression may be of a uLaw, A-Law, 80 PCM or other common format, but may also be of a format that is more usable for voice recognition functions such as extraction of voice recognition parameters.

Radio transceiver subsystem 30 receives digital baseband and control signals from ASIC 24. Radio transceiver subsystem 30 contains a RF switch for controlling transmit/receive direction and the RF antenna. Various integrated chips are available to perform this function such as the Texas Instrument TRF 6900 or the Microlinear Tokaido IC. The choice of chipset depends on the cost and RF throughput requirements of the system. Additional electronics such as filters, crystals and external RF switches may also be needed depending on the chip type selected.

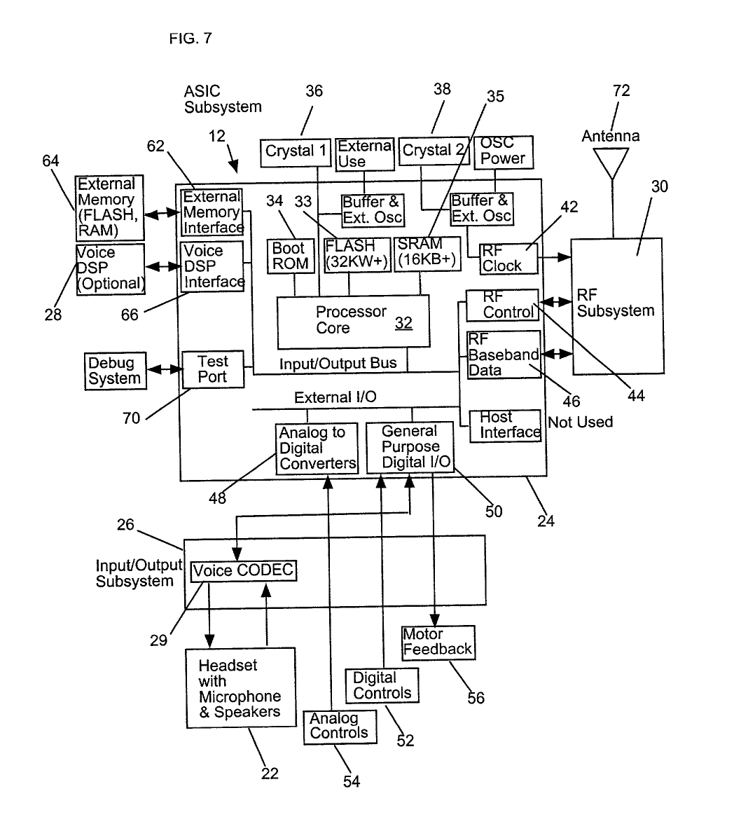

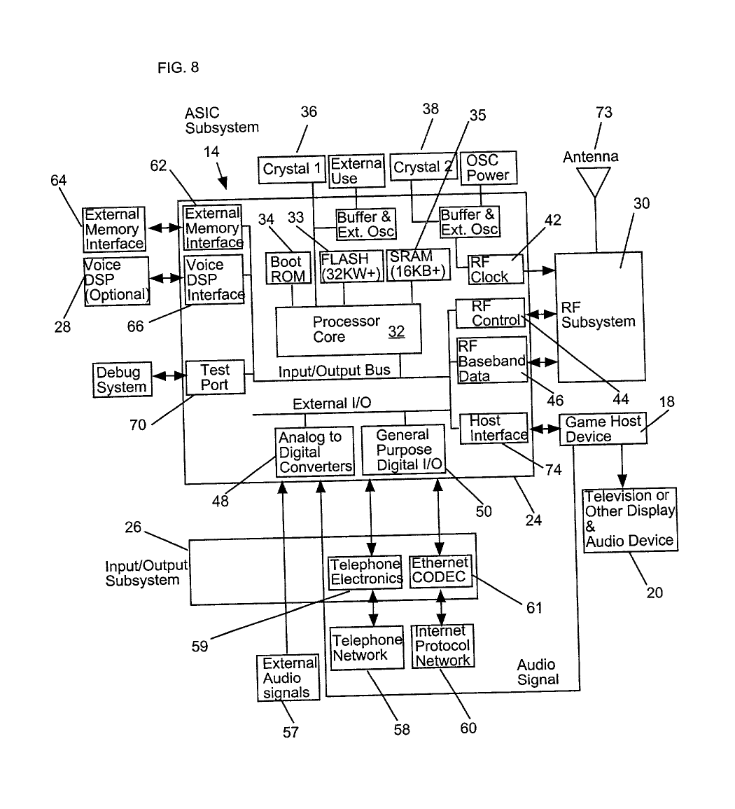

FIGS. 7 and 8 show typical controller 12 and base transceiver 14 systems respectively. Both utilize an ASIC 24 that greatly simplifies the overall design by integrating many of the system functions. In both devices ASIC 24 forms the core of the systems and has many common functions. The input and output functions in controller 12 versus base transceiver 14 are implemented differently, but the core design philosophy is the same.

ASIC 24 contains a central processor core 32 that coordinates all functions of each device. Attached to ASIC 24 or contained internally are various types of volatile and nonvolatile memory to store program code, operating parameters and run-time variables. A boot read only memory (ROM) 34 is used during start up to perform initialization and to then pass over control to the main operating program. Flash memory 33 and Random Access Memory (RAM) 35 of various types is used internally or externally 64.

Two or more crystal references 36 and 38 can be connected to system 10. The first crystal 36 is used as an internal oscillator for ASIC 24 and potentially for the RF subsystem 30 if this subsystem operates at the same frequency as ASIC 24. If not, then second crystal 38 drives another oscillator to serve as the clock source 42 for RF Subsystem 30. RF control 44 and RF baseband 46 interfaces control the operation of RF subsystem 30 and supply or receive data to or from RF subsystem 30.

Analog to digital converters 48 and general purpose digital input/output interfaces 50 collect or supply analog or digital signals from the external environment. For controller 12 this includes game controller 12 input/output such as digital buttons 52, analog buttons 54 and joysticks/d-pads 52,54, speakers, microphones 22 and feedback motor 56. As an alternative to the voice CODEC (coder/decoder) 29 an additional digital-to-analog converter interface could be added to the ASIC 24.

Base transceiver 14 supports external audio signals 57, an audio signal from game host device 18, telephony interface 59 (with extra telephony electronics to detect on/off hook signaling and potentially caller ID) and a data network interface 61 such as an ethernet coder/decoder.

Common to both controller 12 and base transceiver 14 is an external memory interface 62 for adding additional external memory 64, a voice DSP interface 66 for interfacing to a voice DSP 28 and a test port 70 for debugging and testing during development and manufacturing. Voice DSP 28 is optional in controller 12 as voice processing may be centralized in base transceiver 14 or in the host device 18 by sharing this function across multiple controllers 12.

Both controller 12 and base transceiver 14 also have a similar RF subsystem 30 which both sends and receives digital data through an antenna 72 and 73 respectively connected to each device.

Uniquely used by the base transceiver 14 is a host interface 74 tailored to the characteristics of game host device 18. Game host device 18 is interfaced to display device 20 with an audio output capability.

Five audio modes are supported by system 10: 1) normal audio—audio is passed through system 10 without interpretation as output to controllers 12 when audio is present from the host or external audio input sources; 2) bi-directional audio—bi-directional voice transmissions to support an audio telecommunication session; 3) gaming audio—voice commands input at controller 12 are interpreted in the gaming context (as controller 12 input or sets of inputs); 4) keyboard audio—voice commands and key presses input at controller 12 are interpreted as a virtual keyboard for web browsing, e-mail, and other applications where a keyboard and or mouse-like input is useful; and 5) program audio—custom voice commands are added to system 10.

In normal mode, voice output from base transceiver 14 is sent to controller 12 speakers or headset 22 and no voice input is accepted from controllers 12. This is the power up system default. Audio signals are output at controller 12 any time base transceiver 14 receives audio signals or generates audio based on commands from its external input/output subsystem 26 or game host device 18.

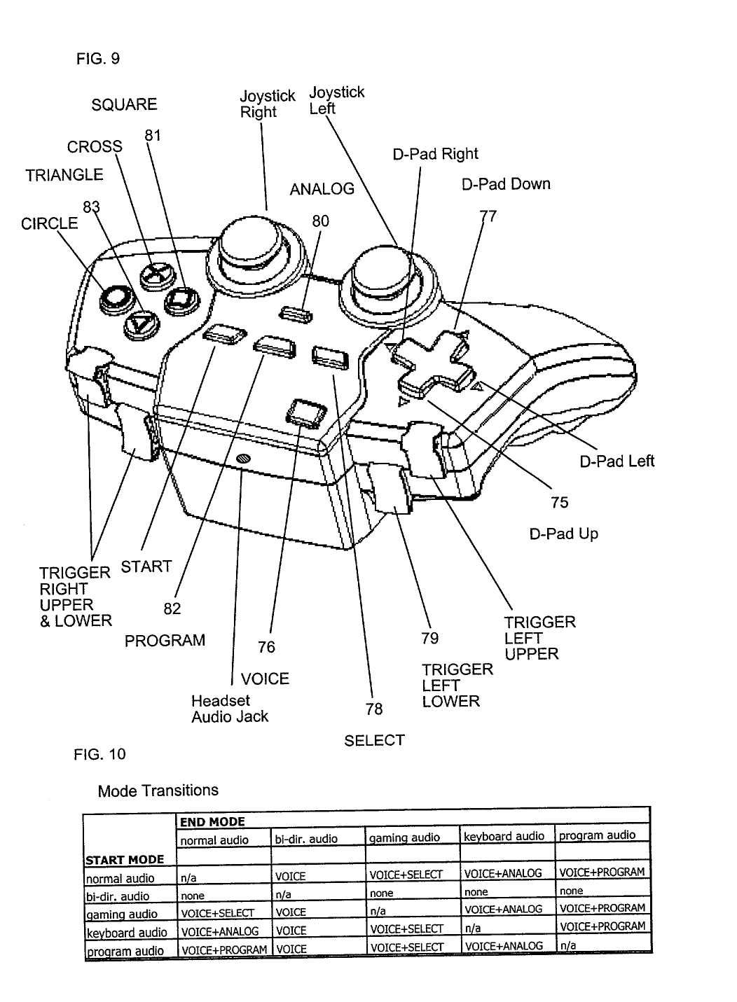

Bi-directional audio mode is entered during a telephone call or similar bi-directional audio session where base transceiver 14 sends an incoming call tone and an incoming call message command to controller 12. The user of controller 12 hears the tone and presses a VOICE key 76 on controller 12, as shown in FIG. 9, to pick up the call. This mode exits to the previous audio mode when the telecommunications session is complete.

In one embodiment of the invention, gaming audio mode is entered when VOICE key 76 and SELECT key 78 are pressed simultaneously and the name of an available game profile is spoken. Profiles are covered later in detail. This mode is exited to normal audio mode when the VOICE key 76 and SELECT key 78 are pressed again. The keyboard audio mode is entered when the VOICE key 76 and ANALOG key 80 are pressed simultaneously and the name of an available keyboard profile is spoken. This mode is exited to normal mode when the VOICE key 76 and ANALOG key 80 are pressed again. Program audio mode is entered when the VOICE key 76 and PROGRAM key 82 are pressed simultaneously. Program audio mode is exited when the VOICE key 76 and PROGRAM key 82 are pressed again.

Various other mode transitions are possible since jumping between modes is also supported as illustrated in FIG. 10. Key entries required to complete transitions are shown in the center of the grid. When a transition occurs by default without key presses “none” is shown and the system returns to the previous state when the mode is complete. Starting and ending modes are shown on the vertical and horizontal axes respectively.

The above controller 12 key sequences are representative only and may be replaced by other sequences depending on the nature and number of buttons on controller 12. More voice recognized commands could be used for controllers 12 having a minimum of input keys, or a longer sequence of simultaneous input keys could be pressed.

In normal audio mode, when the users do not wish to disturb other individuals in a common area, audio signals are routed by cabling from game host device 18 to input/output subsystem 26 audio inputs for game host device 18 on base transceiver 14 as seen in FIG. 8. Then the game host device 18 audio signal is passed to the analog to digital converter 48 input on ASIC 24 of base transceiver 14. If a given user wants to have customized audio input, an external audio signal 57 can be connected to an individual respective audio input on the base transceiver input/output subsystem 26.

Base transceiver processor core 32 digitally mixes the signals from game host device 18 and the individual audio source, if present, and sends the combined signal to RF subsystem 30 by the RF baseband data 46 and RF control 44 interfaces along with other controller-destined data.

In the transmit function, RF subsystem 30 modulates the combined signal and transmits the signal through base transceiver antenna 73. As seen in FIG. 7, at the controller 12 end, antenna 72 receives the signal and the RF subsystem 30 demodulates it and converts it into digital format. Control and data signal information is passed to controller processor core 32 by the controller's RF baseband data 46 and RF control 44 interfaces. Digital signals destined for the parts of controller 12 are separated and passed to the various sub-elements of the controller 12.

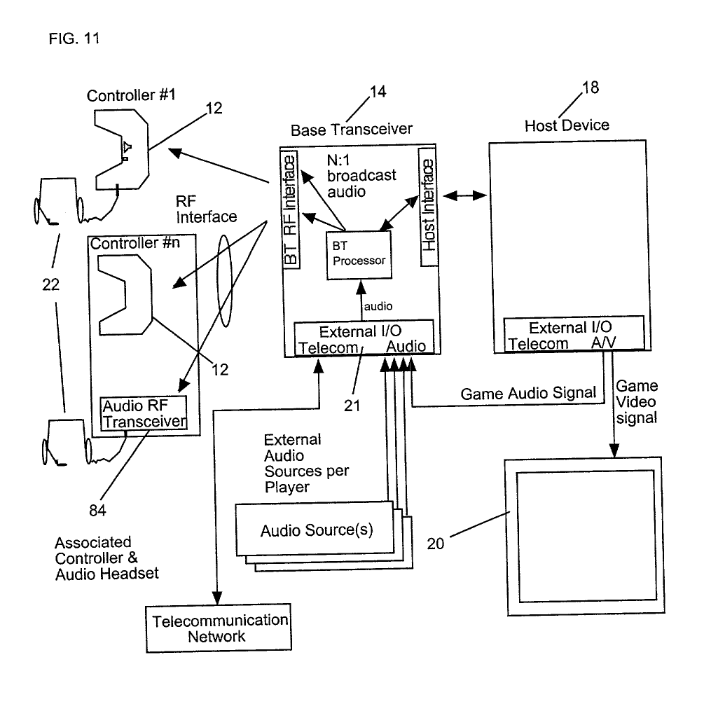

In another case, as illustrated in FIG. 11, where controller 12 does not have an audio capability, a separate audio RF transceiver 84 associated with controller 12 by base transceiver 14 may receive audio signals on behalf of controller 12. External audio signals are received by the audio RF transceiver 84 by plugging an audio source into the base transceiver 14 audio input that corresponds to the RF link going to the audio RF transceiver 84. Game host device 18 broadcast audio is also provided to the audio RF transceiver 84 by the mixing function described earlier. The game host device 18 application uses a configuration option that supports this mode of operation if individualized game audio information is used since the audio for controller 12 should be sent to a different game host device 18 game controller port corresponding to audio RF transceiver 84. Alternately, base transceiver 14 could perform the appropriate audio signal redirection function.

In this manner system 10 provides both a targeted or private broadcast audio function and personalized supplementary audio to each user of each controller 12. In the second case these audio functions are provided to the user of a controller 12 which does not have an audio capability.

Headset 22 provides unique functions and may include any of several noise cancellation techniques to improve the user experience using noise cancellation devices 92. When a user is listening to their particular audio signal, environment noise and sound from other players can be cancelled out so that user only hears the audio signal destined for the corresponding controller 12.

This feature is particularly useful both to increase the quality of the experience, but also in the case of multi-player games and activities where each of the players is speaking into a microphone to communicate or is controlling game activity by voice activation. This unique capability effectively isolates each player in a personalized audio space.

Another noise cancellation feature included in headset 22 is a two-microphone arrangement where environmental noise is subtracted from voice command signals during voice transmissions of a user at a given controller 12. This not only improves the audio quality but also increases the accuracy of voice recognition by filtering out environmental noise and the voice signals from other players in a common area. Otherwise, one player can loudly request an action such as “flaps up” and all other controllers 12 might inadvertently recognize this command and also adjust their respective flaps.

In another situation, the audio signal sent to a controller 12 may be further mixed with an audio signal targeted to an individual user. Game host device 18 sends commands to generate a voice or tone signal or sends a digitally encoded audio stream to base transceiver 14 through host interface 74. Such targeted audio is configured by a graphical user interface provided by the game host device 18 application and set during initial game host device 18 set up or as customized for a particular game.

Voice commands include a code that maps to a given phrase or tone. This command is interpreted by base transceiver processor core 32 running a command parsing application and converted to speech using the attached voice DSP 28. Voice DSP 28 generates the appropriate digital audio signal and passes this signal back to base transceiver processor core 32. Processor core 32 then mixes the generated digital audio signal with any externally supplied audio signals and sends it wirelessly to the appropriate controller 12 as described above.

The tone or voice phrases can be used to provide supplemental information to individual users. In one case information specific to a particular game situation might be provided. In another case the tone might tell the user that a telephone call or e-mail message is incoming.

In another embodiment game host device 18 may provide an encoded audio stream to base transceiver 14 through host interface 74 and instructions as to its disposition. The audio stream can be mixed with one player's audio signals as described above or alternately might be combined with one or more user's audio signals. Audio to teams of players could be coordinated in this fashion or alternately the digital audio signal could be broadcast to all players as an alternative to the external wired configuration discussed earlier. Various types of audio encoding are supported including mono, stereo, and other multi-channel audio formats by changing the firmware resident in the base transceiver 14.

Voice input capabilities are uniquely provided by system 10. With reference to the embodiments illustrated in FIG. 7 and FIG. 8, a voice signal is captured by headset 22, processed by a voice CODEC 29, sent to the controller's or audio RF transceiver's ASIC 24, processed by processor core 32 in ASIC 24, and then transmitted to base transceiver 14 through controller 12 or audio RF transceiver's RF subsystem 30 and antenna 72.

Voice CODEC 29 performs analog to digital conversion and compresses the voice signal in preparation for wireless transmission. This compression saves on transmission bandwidth and increases the system 10 voice carrying capacity.

Voice DSP 28 can be located in controller 12 or audio RF transceiver 84 to provide voice command recognition functionality and additional signal processing functions. Voice command recognition is preferably located in base transceiver 14 or can be simulated in a host device 18 application. As shown in FIG. 7, if voice DSP 28 is located in controller 12 or audio RF transceiver 84, voice command recognition is performed locally and the resulting commands and input are sent in command format to the base transceiver 14. This technique could be used where bandwidth is at a premium, but in such situations real time audio sessions such as telephone calls may not be possible.

In another embodiment, using a controller voice DSP 28, the audio signal can be further preprocessed using a fast fourier transform (FFT) technique to characterize the frequency spectrum of a given audio input signal. This approach is well known in the art from MPEG (Motion Picture Experts Group) audio encoding techniques. Frequency band signal strengths can be parameterized. Dominant frequency band parameter values of the audio signal can then be selected using various aural modeling and selection techniques. This results in an extremely compact representation of the audio signal. These parameters are then transmitted instead of the audio signal. Parameterized signals can be decoded at the base transceiver 14 or host device 18 to reconstruct the audio signal or to be used as input to the voice recognition process.

In the preferred method, the compressed voice signal from controller 12 is received by base transceiver 14. Referring to FIG. 8, the signal passes from the base transceiver's antenna 73 to RF subsystem 30 through the RF interface 46 to base transceiver processor core 32. Base transceiver processor core 32 separates the voice signal from other controller 12 signals such as user inputs from button presses and analog controls.

A voice signal may be processed by voice DSP 28 to recognize spoken words and characters or passed directly to either the host or to the external telecommunication interface depending on the operating mode currently activated.

For voice recognition, the voice signal is sent to voice DSP 28. Voice DSP 28 returns a command code to base transceiver processor core 32 for further interpretation. This code corresponds to an alphanumeric character, a single host command or a sequential command set as interpreted by the base transceiver 14 processor application. Appropriate command or commands are sent to the game host device 18 application by host interface 74.

In the case of host-base voice recognition, software on the host device 18, recognizing voice commands from digital audio streams, could be implemented instead of the voice DSP approach described above. In this case audio streams would be passed from the base transceiver 14 to the host device 18 through the host interface 74. These voice commands could be used directly by the host device 18 to control gaming, Internet, telecommunications or other such host applications.

During a telephone call the system enters the bi-directional audio mode. Referring to FIG. 8, when a call is incoming, the telephone electronics 59 in the base transceiver 14 input/output system 26 detect an incoming call. A signal is sent by general purpose digital input/output interface 26 to processor core 32. Processor core 32 recognizes a phone call as incoming and directs that a ring tone (generated by voice DSP 28 or processor core 32) be mixed with the audio signals currently being broadcast to the first controller 12 of base transceiver 14 controller group. At the same time an “incoming call” message is sent to controller 12. To prevent the game from being interrupted a “pause” command, typically found in most gaming applications is also sent to the game host device 18 by processor core 32 by the host interface 74.

Upon hearing the tone in headset 22, the target user presses VOICE key 76 on controller 12 as shown in FIG. 9. As seen in FIG. 7, this state change is recognized by the general purpose digital input/output subsystem 26 and controller processor core 32 prepares a message for base transceiver 14 from the first controller 12. This message is sent by the RF baseband data interface 46 to RF subsystem 30 and then transmitted to base transceiver 14 by controller antenna 72.

Referring to FIG. 8, base transceiver 14 receives this message by antenna 73, demodulates the message in RF subsystem 30, and passes the message to the base transceiver processor core 32. Recognizing that VOICE key 76 has been pressed, base transceiver 14 ceases tone generation.

Next all other audio signals to the first controller 12 are stopped by base transceiver 12 and the audio signal from the incoming telephone call is routed to the first controller 12 like other audio signals described previously. The telephone electronics 59 contain an analog to digital converter to convert the telephone conversation to digital format as it comes into the system and a digital to analog converter to convert voice digital signals to an analog signal when leaving the system.

When the telephone conversation is finished the caller hangs up or the user presses VOICE key 76 again. In the first case base transceiver processor core 32 recognizes the transition from control signals sent from the telephone electronics 59 and re-mixes game and/or external audio signals for transmission to controller 12 in a configuration that existed prior to the telephone call. A message is sent by base transceiver processor core 32 (FIG. 8) to the controller processor core 32 (FIG. 7) by the wireless RF link telling controller 12 to return to its previous audio mode. Game host device 18 is also sent a “pause-off” command by the host interface 74 to resume the game play or other application interrupted by the telephone call.

If VOICE key 76 is pressed this transition is converted to a message by controller 12 and sent to base transceiver 14 in a similar method as described above. As seen in FIG. 8, base transceiver processor core 32 receives this message and sends a “hang up” control signal by way of general purpose digital I/O 50 to the telephone electronics in input/output subsystem 26 of base transceiver 14. This disconnects and ends the telephone call. The audio mode on controller 12 is returned to its previous state and game host device 18 is sent a “pause-off” command by the host interface 74 to resume the game play interrupted by the telephone call. A similar method can be used for Internet telephony, Internet chat or similar point-point or point to multi-point bi-directional voice sessions.

Three audio modes are associated with voice command recognition: 1) game audio; 2) keyboard audio; and 3) program audio. The first two modes accept voice command inputs from controller 12 and these inputs are converted into game host device 18 commands by base transceiver 14. The third mode is used to program new customized user voice commands and to organize these commands into profiles which may be stored on base transceiver 14 or game host device 18 or transferred to controller 12 to facilitate downloading it to a second base transceiver 14.

The game audio mode is preferably entered by simultaneously pressing VOICE key 76 and SELECT key 78 and then speaking the name of an available profile. Available profiles can be listed in the program audio mode if the user is unsure of what profiles are supported on a given system. A default game audio mode profile may also be stored in flash memory 33 or 64 and retrieved if no profile is specified within a few seconds. This mode associates a voice command to a controller 12 command input or sequence of controller 12 command inputs as defined by the user. In the case of the keyboard audio mode, predefined controller 12 key mappings and voice commands exist but new commands may be created from predefined voice commands. Keyboard audio mode profiles are created and managed separately from game audio mode profiles.

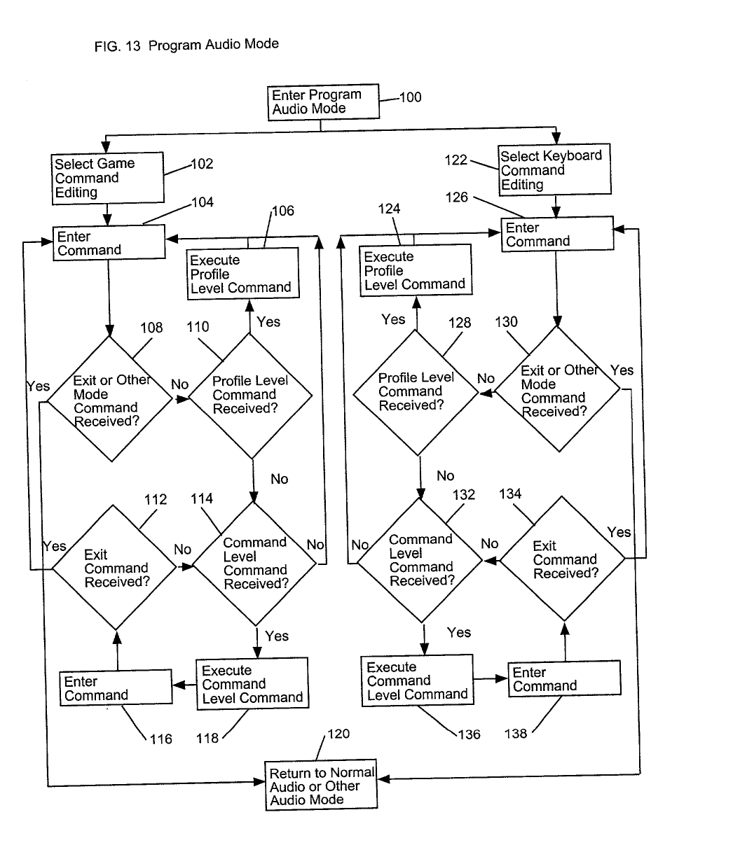

To define user-defined voice commands the user enters the program audio mode to create a profile and to define voice gaming or keyboard commands. A profile is set of gaming or keyboard commands used to control a host device 18 gaming application or a host device 18 keyboard-based application such as e-mail or web browsing. To enter the program audio mode the VOICE key 76 and PROGRAM key 82 are pressed simultaneously. As shown in FIG. 13, step 100, this key combination is detected by controller processor core 32 through its input interfaces. Controller processor core 32 constructs a “program mode” message and sends this to base transceiver 14. Base transceiver processor core 32 receives this message and prepares to receive and process voice command customization key presses and voice commands.

If the user presses the SELECT key 78 the system prepares to define custom game voice commands per 102, FIG. 13. If the user presses the ANALOG key 80 the system prepares to define custom keyboard voice commands per 122. Alternatively if controllers 12 have limited button capability base transceiver 14 can listen for the “game” and “keyboard” voice commands to determine what feature is activated. In either case the voice command definition process and command parsing process are organized in a similar fashion.

As seen in FIG. 13 at the highest level, profile level commands are processed. Within each profile, voice commands are processed at the command level. In FIG. 13 as mentioned above the user can edit game commands starting at 102 or keyboard commands starting at 122. The editing processes is identical in either case, except profiles created in the game command editing process and the keyboard command editing process are only used in the corresponding game audio mode and keyboard audio mode respectively. The game command editing process is illustrative of the identical keyboard command editing process. In FIG. 13 operations 104, 106, 108 and 110 are profile level operations and operations 112, 114, 116 and 118 are command level operations. Upon entering the profile level the user enters a command 104. This command is checked to see if it is an exit command or a command to transition to another mode 108. If an exit command as defined in line 168 of FIG. 15 is detected or a command to transition to another mode is found, the process returns to normal audio mode or another audio mode 120. If the command is a profile level command 110, as identified in column 170 of FIG. 15, the command is executed 106 and another command can then be entered 104. If in operation 110 a non-profile level command is received, control flows to 114. If the command is a command level command the command is executed 118 and another command level command input is collected 116. If the input is not recognizable in 114, the user is asked for input again in line 104. After entering a command 116, the command is checked to see if it is an exit type in 112. If it is, control returns to the profile level 104, otherwise it is checked to see if it is a command level command 114 and so on. A user returns or “exits” to the profile level from the command level by pressing the VOICE key 76 and PROGRAM key 82 simultaneously, and this use is detected at 112. If the user wishes to leave the program audio mode entirely the user repeats this sequence again and returns to the normal audio mode as outlined above.

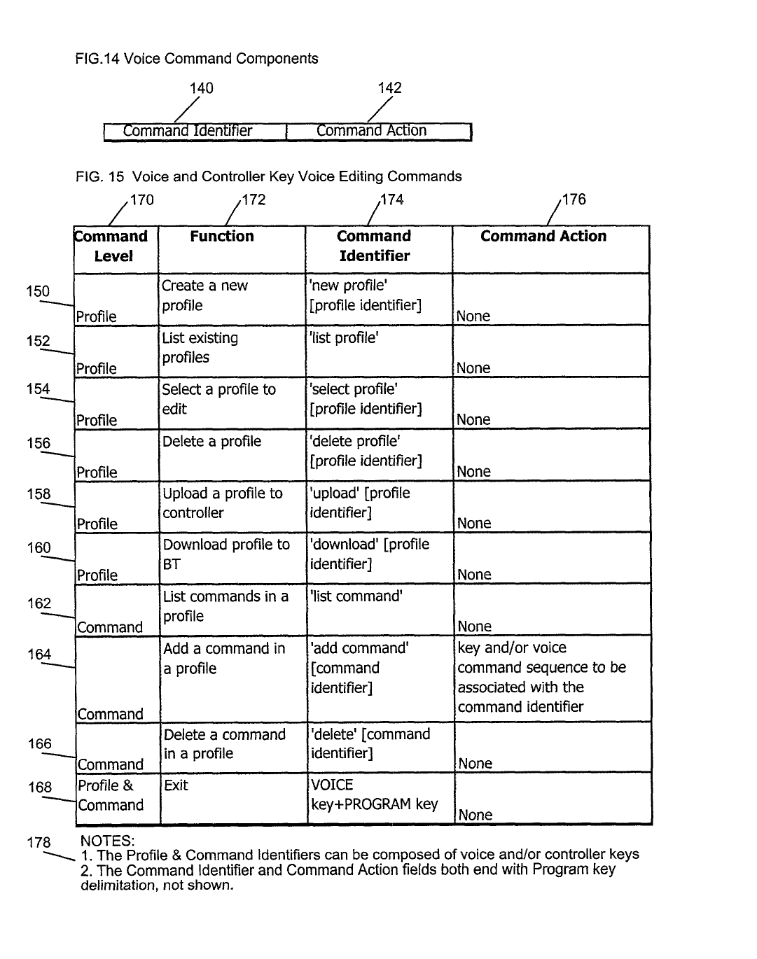

A set of voice command editing commands customizes and manipulates profiles. As shown in FIG. 14, these commands are composed of a command identifier field 140 and a command action field 142. During the command editing process the PROGRAM key 82 delimits the end of a command and the transition between the command identifier field 140 to the command action field 142 entry. As described by note 178, the PROGRAM key 82 entry is not shown in FIG. 15 but can be present. The command identifier 140 and command action fields 142 can both be composed of voice commands and/or controller 12 key commands in various combinations with the exception of the VOICE key 76, SELECT key 78, ANALOG key 80, and PROGRAM key 82 and the voice editing commands (shown in FIG. 15) which are generally reserved for general mode control functions. A notable exception to the use of reserved keys is the case of the command identifier field 140, where using a controller 12 key at the end of a spoken command allows for easier identification of the command end point and parsing of this command.

As shown in FIG. 15, the voice editing commands supported include “new profile” 150, “list profile” 152, “select profile” 154, “delete profile” 156, “list command” 162, “add command” 164, “delete command” 166, “upload profile” 158, “download profile” 160 and “exit” 168. The columns of this table in FIG. 15 provide the command level 170, command function 172 and format by command identifier 174 and command action 176 fields of these commands. The system supports two levels of operation, the profile level and the command level.

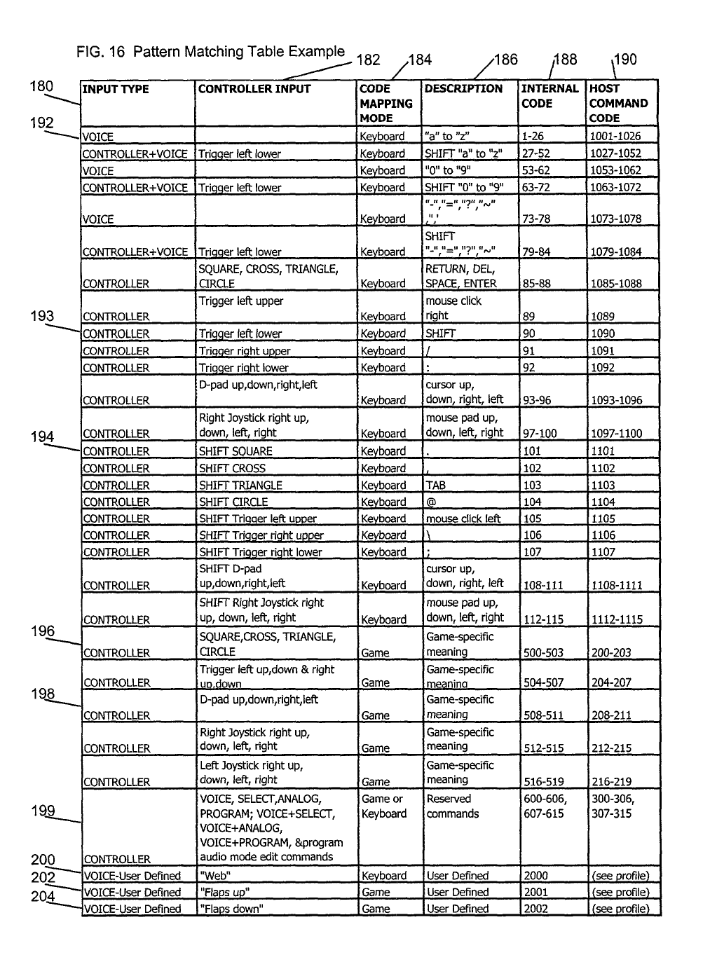

As shown in representative sample tables in FIGS. 16, 17 and 18, the voice control-related commands are stored in two levels of tables in the base transceiver flash memory 33 or 64. The actual internal codes and the host command codes used will depend on the nature of the specific target host system. The description columns 186, 210 and 220 are shown for readability purposes and are not used in the actual implementation. At the first level, controller 12 key and voice patterns are stored in a pattern matching table shown in FIG. 16. Which internal and host command codes used from the table depend on the mode 184 the system is in. When in normal mode, bi-directional mode, gaming mode and the game sub-mode of program audio mode, a “game” code mapping mode is used. When in keyboard mode or the keyboard sub-mode of program audio mode, a “keyboard” code mapping mode is used. The pattern table associates an input pattern to an internal control code and a host command code. Internal control codes and host command codes are chosen to be mutually exclusive. As an example of the use of codes in FIG. 16 line 192, keyboard “a” voice pattern is associated with an internal command code of 1 (column 188) and host command code of 1001 (column 190). If no host command codes are defined in the pattern table, the base transceiver processor 32 searches the active profile table for the internal code and the associated host command code list. For example in FIG. 16, a user defined “flaps up” voice pattern used during gaming is associated with an internal command code 2001 (line 202, column 188), but the host command code entry is blank (line 202, column 190). From the profile table in FIG. 18 line 226, column 224, host command codes of 202 (TRIANGLE) and 208 (D-Pad Up) are associated with the voice pattern. The definition of these host commands is found in FIG. 16 in line 196 column 190 and line 198 column 190.

In the second level of tables, a profile table is used to convert a blend of internal control codes into a series of actionable host command codes. Profile tables are unique to each audio mode, since the controller 12 keys are used for game control in game audio mode and used for punctuation and other input functions in the keyboard audio mode. When a user is in the game or keyboard audio modes, the base transceiver processor 32 receives audio signals and internal key codes from the controller 12. It then sends audio signals to the voice DSP 28 for interpretation. The voice DSP 28 returns the internal control codes associated with the audio patterns. The base transceiver processor 32 then combines the audio internal control codes with the controller 12 key internal control codes and uses the result to index the profile table to determine the actionable host command codes. The host command codes are directly recognizable by the host device 18.

The following are examples of blended command types. In one case, the voice command identifier field can consist of a voice component and controller 12 key component, the internal code entry in the profile table will consist of more than one internal command such as the “flaps up” example and SELECT key 78 line 229 of FIG. 18. This is a special case where the reserved SELECT key 78 is used to delimit the end of a voice command portion of a command identifier field. In another case when a user is in the program audio mode, they can create blended voice command action fields 142. As shown in FIG. 15 line 164 and note 178, a controller 12 key input and/or a voice input may be used to generate an entry for the command action field 142. During this process, the voice DSP 28 interprets the voice input and outputs an internal control code. The base transceiver processor 32 then looks this internal control code up in the pattern matching table shown in FIG. 16 to determine the host command code sequence. If the voice command is user defined no host command code sequence will exist in the pattern matching table FIG. 16, and the base transceiver processor 32 then looks in the profile table being edited for a voice command and corresponding host command sequence. Thus voice command input used while creating the command action field 142 is converted to the appropriate host command code sequence and entered into the host command code field 142 of the profile table along with controller 12 key host command code inputs to create a new blended command input.

Whereas controller 12 key internal codes are predefined, voice patterns can be either pre-defined with pre-defined internal codes or user defined in program audio mode with voice DSP 28 assigned internal codes. When a new audio command is recorded using the add command 164, the voice DSP 28 stores a representation of the new audio command, assigns a new internal code to the recorded pattern and passes this code to the base transceiver processor 32. The base transceiver processor 32 then stores this new code in the internal code column 188 of the pattern matching table and in the internal code column 212 or 222 of the profile table being edited. The base transceiver 14 then assigns a host command code sequence derived from the command action field of the “add command” command (shown in FIG. 15 line 164 column 176).

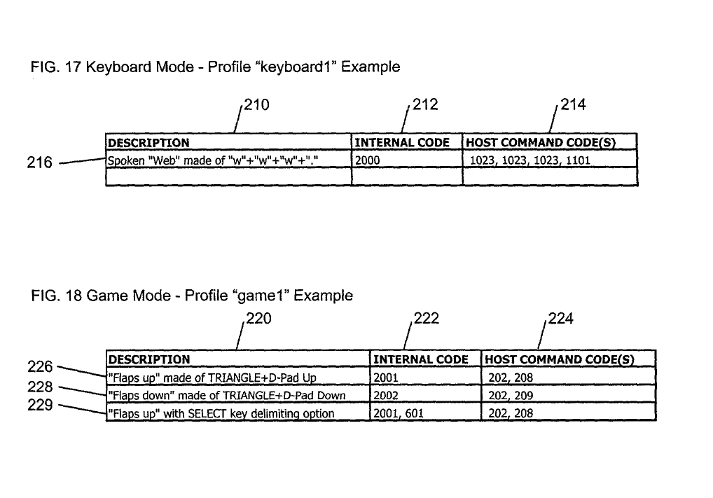

The following example illustrates the use of program audio mode editing commands to create the table found in “keyboard” profile found in FIG. 17. Assuming the system starts in normal audio mode, the user creates the table found in FIG. 17 by following the steps outlined below. As in FIG. 13, the user presses the VOICE key 76 and the PROGRAM key 82 simultaneously to enter the program audio mode 100. Next the user selects the keyboard command editing mode 122 as shown in FIG. 13, by depressing the ANALOG key 80 and the system prepares for command entry 126. A new profile is then created by verbally entering the new profile command 150 (FIG. 15), “new profile keyboard1” at the controller 12 and transmitting this audio signal to the base transceiver processor 32. The base transceiver processor 32 executes the command 124 by asking the voice DSP 28 to process the “keyboard1” voice pattern and return an internal code. This code is entered in the pattern table and is used for later retrieval of the “keyboard1” profile upon entry into the keyboard mode. The base transceiver 14 also creates a “keyboard1” profile table in anticipation of receiving commands within this profile. During the editing process this profile table is stored in RAM 35 but is stored in non-volatile flash 33 or 64 once editing is complete. Control then returns to 126 to accept the next command.

The user then enters the commands within the profile. In FIG. 13, at step 126 the user enters the command level command “add command web” 164 followed by the PROGRAM key 82 followed by the command action “w”, “w”, “w”, “.” followed by the PROGRAM key 82 to denote the end of the command. The command level command input is transmitted to the base transceiver 14 from the controller 12 for processing. The base transceiver processor 32, using the voice DSP 28, recognizes the command level “add command” 164 command and control passes through steps 130, 128 and 132 to begin processing at step 136 as shown in FIG. 13. Following the same process for entering the profile name “keyboard1”, a code 2000 for the “web” voice pattern is assigned by the voice DSP 28 and entered into the pattern table line 200 by the base transceiver processor 32. Next the command action 142 portion of the command is processed. “W” command actions are spoken and thus preprocessed by the voice DSP 28 to derive an internal code, whereas “.” is entered by simultaneously depressing the Trigger left lower key 79 and SQUARE key 81. These voice inputs and key presses are converted into internal codes 23,23,23 and 101 as shown in line 192 and line 194 of FIG. 16 by base transceiver processor 32. Using the pattern matching table FIG. 16, the base transceiver processor 32 derives the host command code sequence (1023, 1023, 1023, 1101) from line 192 and line 194 from the host command code column 190. The internal command code (2000) for “web” and the host command codes for the command action are then entered into the “keyboard1” table FIG. 17, by the base transceiver processor 32 in the internal code 212 and host command code 214 column fields respectively of line 216. The RAM 35 table record is then copied to a non-volatile flash 33 or 64 version of the profile table to ensure the persistence of this command if power is removed.

Now that the creation of the “keyboard1” profile table shown in FIG. 17 is complete, the user exits the program audio mode. To exit the program audio mode, the exit command 168 (simultaneous VOICE key 76 and PROGRAM key 82 presses) is pressed once to return to the profile mode by steps 138 and 134 of FIG. 13 and then again to return to normal audio mode by way of steps 126, 130 and 120 of FIG. 13.

The “game1” game-related profile table found in FIG. 18 can be created using a similar method, but selecting the game audio editing mode steps 100 and 102 in FIG. 13. In this case, however, the command action 142 field of the “flaps up” and “flaps down” commands are created solely from controller 12 key input. The TRIANGLE key 83 and D-pad up key 75 are pressed for the “flaps up” action and the TRIANGLE key 83 and D-pad down key 77 are pressed for the “flaps down” action. These actions in program audio mode trigger the creation of a data entry in column 224 of lines 226 and 228 respectively of the table shown in FIG. 18. In the table shown in FIG. 16, the internal and host command codes for the TRIANGLE key 83, the D-pad up key 75 and the D-pad down key 77 can be found in columns 188 and 190 of line 196 and line 198 respectively. The internal code for the “flaps up” and “flap down” audio input can be found in column 188 of lines 202 and 204 respectively. These values from FIG. 16 are used to fill in the “game1” profile table in FIG. 18. Also included in FIG. 18 is a special option mode where the SELECT key 78 is combined with the “flaps up” voice input (line 229) in the definition of the command identifier field. This allows the voice input to be more clearly delimited. The internal code for the SELECT key 78 is found in line 199, column 188 in FIG. 16. Because the SELECT key performs a delimiting function, there is no corresponding entry in the host command code column 224 of line 229 in FIG. 18.

Following the initial profile table creation, several commands can be used to manipulate entries in the profile table. With reference to FIG. 15, the list profile command 152 is used to determine which profiles are available for use in either game audio mode or keyboard audio mode. When a profile is listed, the base transceiver processor 32 requests the voice DSP 28 to generate an audio signal listing the available profiles by providing the internal codes corresponding to the profile names to the voice DSP 28. This signal is directed to the controller 12 speaker/headset by the base transceiver processor 32 to provide user feedback. Select profile command 154 is used to select an existing profile in preparation for editing the commands within the selected profile. Delete profile command 156 will delete a requested profile. At the command level, list command 162 sends an audio signal with a speech listing of the commands within a profile from the base transceiver 14 to the controller 12 speaker/headset 22 to provide user feedback. Delete command 166 deletes the identified command.

If the user wishes to upload the voice command profile to the user controller 12 so the user can transfer the profile to another base transceiver 14 system, the user issues the upload profile command 158. In this way the user can use a favorite game voice command settings as the user moves to another voice-command equipped base transceiver 14 system. One or more such profiles could be uploaded depending on the memory capacity of controller 12. Newly uploaded profiles over write existing profiles entered during a previous session in the program audio mode.

After a wireless connection is established from the controller 12 to another base transceiver 14, the user can enter the program audio mode there and issue the download profile command 160 for each profile that the user wishes to download to the other base transceiver 14 system. Thus profiles are not only persistent but also portable between base transceiver 14 systems.

After the program audio mode is exited, the user can then use either the game or keyboard voice commands. The game audio mode is entered when the user selects VOICE key 76 and SELECT key 78 simultaneously. Next the user speaks the name of the profile to be activated e.g. “game1”. Pushing these keys and the audio input is detected by controller processor core 32 and a message is sent to the base transceiver's processor core 32 to recognize (using voice DSP 28) and recall the desired profile “game1” and to initiate listening for game-related commands. From this point on until the user selects VOICE key 76 and SELECT key 78 simultaneously or some other key sequence that causes a mode transition, words spoken into headset 22 microphone or controller 12 microphone are sent to base transceiver 14 for voice command recognition and the derived game commands sent to the game host device 18 in the native host defined command set format.

Similarly when a game host device 18 application requires a keyboard input, the user of controller 12 can select VOICE key 76 and PROGRAM key 82 simultaneously and speaking the name of the profile to be activated. Pushing these keys and the audio input is detected by controller processor core 32 and a message is sent to base transceiver processor core 32 to recognize (using voice DSP 28) and recall the desired profile and to indicate that it should begin listening for keyboard-related commands. If no profile name is provide, the pre-defined keyboard commands are used without reference to a user defined profile. From this point on until the user selects VOICE key 76 and PROGRAM key 82 simultaneously or some other key sequence that causes a mode transition, system 10 will remain in this mode. In this mode, words spoken into headset 22 microphone or controller 12 microphone and controller 12 keys entered are sent to base transceiver 14 for voice command recognition and key recognition. Controller 12 keys are mapped to keyboard key functions as indicated in FIG. 16. From this combined voice and controller 12 key input the derived keyboard commands are sent to game host device 18 as data or in a form recognized as keyboard input by the game host device 18 application.

Alternately, if game host device 18 does not have the capability of receiving keyboard-type commands through its game ports, base transceiver 14 can be equipped with a keyboard-out hardware interface (by the general purpose digital input output interface of ASIC 24). This interface could be connected to an equivalent keyboard-in interface on another location of the game host device 18. Keyboard commands derived from controller-originated voice commands could be sent over this alternate interface.

In the keyboard audio mode, to simplify the simulated keyboard entry process, keys on controller 12 and voice commands are pre-defined as shown in FIG. 16. FIG. 9 shows a sample controller 12 and is representative of the types of input keys/interfaces supported. Controller 12 keys are mapped to common keyboard keys. FIG. 12 shows a representative pre-defined controller 12 key to keyboard key mapping which is part of a larger controller 12 key and voice command mapping shown in FIG. 16 that also includes user-defined voice mappings. As shown in FIG. 16, a SHIFT key 193 can be defined to access the capital letters and keyboard special characters and additional mappings for controller 12.

Pre-defined voice commands for keyboard characters include the remaining alphanumeric keyboard characters. For example “a” to “z”, “0” to “9”, remaining special characters, edit keys, movement keys and the remaining punctuation are predefined as shown in FIG. 16. Combinations of these voice commands can be created as discussed above with reference to the program audio mode.

When various types of modes are invoked, base transceiver processor core 32 can issue activation tones or generate feedback voice phrases, telling the user that a given mode was entered. These tones would be directed to the audio output of the controller 12 engaged in a mode transition.

Audio signals are sent to the user through headset 22 plugged into controller 12 or attached to an independent audio RF transceiver 84 that is associated with a given controller 12 by base transceiver 14.

Game users can mute the audio output of display device 20 and send the audio signals directly to each user controller 12 directly as illustrated in FIG. 2. Each user can thus hear a broadcast audio signal from game host device 18 through their controller headset 22 and other individuals in the same area undertaking different activities are not interrupted.

System 10 permits personalized audio signals supplementary to gaming application audio signals that are targeted to each individual controller 12 and corresponding player. External audio/music signals from a CD player, stereo or other source are input into system 10 or generated by game host device 18. A separate external audio input 21 is provided on base transceiver 14 for each supported controller 12 in addition to the input provided for the game host device 18 audio signal.

When audio signals from both game host device 18 and external sources are present, they are mixed by base transceiver 14. The player can listen to their favorite music in the background while still hearing all audio signals for the game in progress. Conventional games are often configurable so that game related music is turned off while retaining the sound effects associated with basic game actions. The player thus introduces individualized audio sources that are integrated into a common audio stream by system 10.

The invention also generates or transmits voice messages or tones feedback in response to feedback. Such feedback is received in the form of commands, data streams or encoded voice data streams from the game host device 18 or as generated by base transceiver 14. Commands or data streams are converted into tones or voice messages by base transceiver 14 or transmitted after decoding, in the case of encoded voice data streams, and mixed with the audio signal being sent to individual game controllers 12.

In this way a game host device 18 with a single audio output to all game players can be enhanced to provide targeted audio feedback to given players. Applications of this include targeted game player-specific audio information such as warnings configured from the video game software setup screen. Base transceiver 14 can also use this facility to provide interactive audio feedback to the user when commands are being executed.

Game host device 18 can provide gaming and other communication features such as Internet and E-mail access. In different embodiments this capability can include notification of e-mail arrival, text-to-speech conversion, and read-out of such messages.

The invention provides high quality voice recognition and low inter-player noise interference. Headsets 22 used by controllers 12 can be equipped with speakers or both speakers and microphones. When headset 22 is plugged in, the internal microphone of controller 12 is de-activated. Also when headset 22 is plugged in, controller 12 speaker (if present) can be disabled.

To support voice command recognition for gaming applications headset 22 has a mechanism 92 to support noise cancellation at the input microphone to filter out environmental noise. To provide audio isolation between players a similar mechanism in headset 22 can cancel any inter-player noise that may interfere with the audio signal coming from controller 12.

The invention permits voice input to be collected by game controller 12 and mapped to a predefined single command or sequence of commands to control the operation of the game host device 18 application. This input is interpreted by either controller 12 or sent to base transceiver 14 or game host device 18 for interpretation. Such input can control gaming and other communications and entertainment applications such as e-mail, web browsing, MP3 music and Internet telephony.

The invention also supports user defined voice commands entered through controller 12 key sequences and user voice input from controller headset 22. Sets of, or “profiles” of such voice commands can be saved on controller 12, base transceiver 14, a memory card or game host device 18. Profiles can be recalled to initialize any controller 12 supported by base transceiver 14, not just the controller 12 upon which the voice command was entered. In this way controller 12 voice command profiles are persistent, portable and device independent.

A single command can be mapped to a single function or a composite command can be created. For a composite command, a single voice command can trigger a rapid sequence of game related commands. Voice commands can be combined or blended with controller 12 key sequences to create a virtual, voice activated keyboard function for manipulating game host device 18 applications (e.g. e-mail, web browsing, option selection). Controller 12 keys are mapped to common functions keyboard and voice commands generate all other simulated keyboard commands. Voice recognition can be switched on or off to transition between various voice and audio modes using controller 12 key sequences. Controller headset 22 of a first controller 12 in a sequence of controllers 12 can provide the speaker and a microphone for an extensive audio telecommunication session.

The wireless functionality of controllers 12 alone or working in conjunction with audio RF transceivers 84 that utilize voice recognition and generation technologies provides a general input and feedback mechanism for keyboard and mouse type input functions. The invention is applicable to the field of bi-directional audio signals and audio control in the family entertainment room environment for video gaming and for other functions such as audio entertainment, informational, computing, and telecommunication applications.

Although the invention has been described in terms of certain preferred embodiments, it will become apparent to those of ordinary skill in the art that modifications and improvements can be made to the inventive concepts herein without departing from the scope of the invention. The embodiments shown herein are merely illustrative of the inventive concepts and should not be interpreted as limiting the scope of the invention.

What is claimed is:

1. A system for wireless interaction between an operator and a program, comprising:
a host device for supporting the program;
a base transceiver engaged with said host device, wherein said base transceiver comprises a processor core, a radio frequency transceiver, and voice recognition and generation capability; and
a controller operable by the operator, wherein said controller comprises a processor core, a radio frequency transceiver for wireless communication with said base transceiver radio frequency transceiver, and an audio input and output interface.

2. A system as recited in claim 1, wherein at least two controllers are in radio frequency transmission with said base transceiver.

3. A system as recited in claim 2, wherein said base transceiver is capable of selectively transmitting an audio signal to at least one of said controllers.

4. A system as recited in claim 2, wherein said base transceiver is capable of receiving multiple audio signals from at least one source, and wherein said base transceiver is further capable of mixing said audio signals for transmission to said controllers.

5. A system as recited in claim 4, wherein said base transceiver is capable of selectively transmitting said audio signals to at least one selected controller.

6. A system as recited in claim 5, wherein said base receiver is capable of selectively configuring a set of said audio signals for transmission to at least one selected controller.

7. A system as recited in claim 2, wherein said host device is capable of being programmed to generate targeted audio signals transmitted to at least one of said controllers.

8. A system as recited in claim 1, wherein said base transceiver is capable of generating audio signals for transmission to at least one of said controllers.

9. A system as recited in claim 5, wherein the audio signal for a given controller without audio capability is redirected to an audio RF transceiver by said base transceiver, where said base transceiver logically associates said controller and said audio RF transceiver as an integrated device.

10. A system as recited in claim 1, wherein said voice recognition and command control capability comprises the capability of blending controller inputs, pre-defined keyboard and controller voice commands and user-defined voice commands.

11. A system as recited in claim 10, wherein said voice recognition capabilities have pre-defined voice commands tailored to a selected application.

12. A system as recited in claim 10, wherein said voice command is composed of command identifier and command action parts.

13. A system as recited in claim 12, wherein the command identifier field is a combination of voice signals and controller key presses.

14. A system as recited in claim 12, wherein the command action field is a combination of voice signals and controller key presses.

15. A system as recited in claim 10, wherein said voice commands and voice signals are capable of being stored in memory and are capable of being transferred from said memory.

16. A system as recited in claim 10, wherein said voice commands are organized into voice-tagged profiles of voice command sets.

17. A system as recited in claim 16, wherein said voice command profile resident in said base transceiver is activatable for a selected controller so that the voice command capability set of the profile is accessible to said controller.

18. A system as recited in claim 16, wherein said voice profile can be uploaded to a controller from a first base transceiver and then downloaded to a second base transceiver.

19. A system as recited in claim 18, wherein a profile downloaded to a second base transceiver from a controller may be activated by a controller associated with said second base transceiver so that the voice command capability set of said profile is accessible to any second base transceiver controller.

20. A system as recited in claim 10, wherein one or more controller input or keyboard input sequences can be initiated by a voice command.

21. A system as recited in claim 10, wherein one or more controller input or keyboard input sequences can be initiated by a voice command in combination with a controller key sequence.

22. A system as recited in claim 1, further comprising an audio telecommunication session supported when said resident host device application is paused until such session has completed.

23. A system as recited in claim 1 wherein said voice recognition and generation capability is at least partially resident in said host device and said base transceiver manages the transfer of audio signals and voice recognition parameters to and from said host device.

24. A system as recited in claim 1, wherein selected functions of said base transceiver are integrated into said host device.

25. A system as recited in claim 1, further comprising an environmental noise cancellation mechanism.

26. A system as recited in claim 1, further comprising a hard wire connection between said controller and said base transceiver.

27. A system as recited in claim 10 further comprising a hard wire connection between said controller and said base transceiver for facilitating said voice recognition and command control capability.
